(19) United States
(12) Patent Application Publication
(10) Pub. No.: US 2018/0169965 A1
(43) Pub. Date: Jun. 21, 2018

(54) ARTICLES PACKAGED IN ULTRASONICALLY SEALED FILMS

(71) Applicants: GENERAL MILLS, INC., Minneapolis, MN (US); BOSCH PACKAGING SYSTEMS AG, Beringen (CH)

(72) Inventors: Michael D. KENTALA, Burnsville, MN (US); Timothy MCCALL, Bryn Mawr, PA (US); Peter L. NOVOTNY, Crystal, MN (US); George A. TUSZKIEWICZ, Plymouth, MN (US); Paul KAFTAN, Donaueschingen (DE)

(21) Appl. No.: 15/617,304

(22) Filed: Jun. 8, 2017

Related U.S. Application Data
(60) Provisional application No. 62/434,551, filed on Dec. 15, 2016.

(51) Int. Cl. B29C 65/00; B29C 65/08; B29C 65/48; B29C 65/50

(52) U.S. Cl. CPC B29C 66/71; B29C 65/08; B65B 51/22; B29C 65/5021; B29C 65/4845

(57) ABSTRACT

A multilayer film includes a base film, a cavitated layer, and a sealing layer. Such films have been found to produce good ultrasonic seals in the cross-machine direction at high speeds.

### RELATED APPLICATION

This application claims the benefit of U.S. Provisional Patent Application No. 62/434,551 filed on Dec. 15, 2016, which application is hereby incorporated by reference in its entirety to the extent that it does not conflict with the disclosure presented herein.

### FIELD

This disclosure generally relates to, among other things, multilayer films for use in high speed ultrasonic sealing processes; to products, such as food stuffs, contained in ultrasonically sealed packages that include the multilayer films; and to methods of ultrasonically sealing the multi-layer films.

### BACKGROUND

A number of different processes exist for sealing packaging films. Each process has advantages and disadvantages. However, a typical goal for large-scale manufacturing is to produce a good seal at high speeds in a cost-effective manner.

Cross seals often limit the speed at which packaging lines can be run because of the short residence time of the sealing equipment on the package-forming film. For example, with rotary cross seal apparatus on a continuous motion system, the time in which seals are formed can be milliseconds or less, even at relative low line speeds. One solution to increasing residence time for sealing in the cross machine direction is to employ an intermittent motion system in which movement in the machine direction is halted to allow sufficient time to form a sufficient seal. However, intermittent motion systems tend to run at lower average speeds than continuous motions systems.

One process for sealing films is heat sealing. Heat sealing often results in a quality seal. Because it takes time for a film to heat up to an appropriate temperature for sealing, films being heat sealed are often run at slower speed than with other sealing processes. A film requiring cross-sealing can be run on a heat seal line at top speeds of, for example, about 70 meters per minute on a continuous motion system. Heat sealing requires the use of thermally stable materials, which limits the film materials that can be employed.

Another process for sealing films is cold sealing. In cold sealing, adhesives are applied to a film to form a seal. Films being cold sealed and requiring a cross-seal can be run at high speeds, such as about 90 meters per minute to about 100 meters per minute on a continuous motion system. Cold sealing, however, can be susceptible to channel leaks. To compensate for, and to minimize, channel leaks, adhesive is often applied to large surface areas of films.

Another process for sealing films is ultrasonic sealing. Ultrasonic sealing often results in a quality seal, but films being fabricated into a package and ultrasonically sealed in a cross machine direction are typically run at slower speeds than with other sealing processes. A film on an ultrasonic Horizontal Form, Fill, Seal (HFFS) sealing line may be run at a top speed of, for example, about 40 meters per minute. Ultrasonic welding on films run at speeds above 40 meters per minute in a cross machine direction seal operation can result in one or more of fracturing of outer layers of the film, poor sealing, and damage at edges of the resulting package adjacent to the cross machine direction seal. The resulting fracturing, poor sealing, or damage may render the seal immediately ineffective or may result in a seal that degrades overtime with, for example, shipping and handling and thereby reduces shelf-life.

### SUMMARY

This disclosure describes, among other things, multilayer films for use in high speed ultrasonic sealing processes. The films may be particularly advantageous when used on ultrasonic sealing manufacturing lines in which at least one seal is in a cross machine direction, such as manufacturing lines in employing rotary cross seal ultrasonic sealing equipment. The multilayer films include a base film comprising one or more layers, a sealing layer, and a cavitated layer between the base film and the sealing layer. As described herein, multilayer films having a cavitated layer between a sealing layer and a base film can be ultrasonically sealed in the cross machine direction with high quality at continuous speeds above 40 meters per minute relative to the source of ultrasonic energy without fracturing or damage. In some embodiments, multilayer films having a cavitated layer between a sealing layer and a base film can be ultrasonically sealed with high quality at continuous speeds up to 75 or more meters per minute without fracturing or damage.

In some embodiments described herein, a packaged article includes the article and packaging in which the article is ultrasonically sealed. The packaging includes a multilayer film. The multilayer film has a base layer, a sealing layer, and a cavitated layer between the base layer and the sealing layer. The article can comprise a foodstuff.

In some embodiments described herein, a method includes providing a first film having a base film comprising one or more layers, a sealing layer, and a cavitated layer between the base film and the sealing layer. The method further includes directing ultrasonic vibrational energy through a first portion of the first film to ultrasonically seal the portion of the first film to a second portion, such as a folded, opposing portion, of the first film or to a second film. The film can be moving at continuous speeds above 40 meters per minute as the ultrasonic energy is directed through the portion of the film, while forming a quality seal in the cross machine direction without associated fracturing or damage to layers of the film.

One or more embodiments of the films, packages, packaged articles, and methods described herein provide one or more advantages over prior films, packages, packaged articles, and methods. Such advantages will be readily understood from the following detailed description.

### BRIEF DESCRIPTION OF THE DRAWINGS

FIG. 1 is a schematic sectional view of an embodiment of a multilayer film.

FIG. 2 is a schematic sectional view of an embodiment of a multilayer film.

FIG. 3 is a schematic drawing of an embodiment of a product sealed within a package.

FIG. 4 is a flow diagram of an ultrasonic sealing process in accordance with embodiments described herein.

FIG. 5 is a flow diagram of a process for ultrasonically sealing an article in a film in accordance with embodiments described herein.

FIG. 6 is a 2-axis plot % failure (bar graph) and density of two comparative films and an example film.

FIG. 7 is a 2-axis plot % failure (bar graph) and modulus in the machine direction of two comparative films and an example film.

FIG. 8 is a 2-axis plot % failure (bar graph) and modulus in the transverse direction of two comparative films and an example film.

FIG. 9 is an image of a cross sealed region of a comparative film.

FIG. 10 is an image of a cross sealed region of an example film.

The schematic drawings are not necessarily to scale. Like numbers used in the drawings refer to like components, steps and the like. However, it will be understood that the use of a number to refer to a component in a given drawing is not intended to limit the component in another drawing labeled with the same number. In addition, the use of different numbers to refer to components in different drawings is not intended to indicate that the different numbered components cannot be the same or similar to other numbered components.

Reference will now be made in greater detail to various embodiments of the subject matter of the present disclosure, some embodiments of which are illustrated in the accompanying drawings.

### DETAILED DESCRIPTION

This disclosure describes, among other things, multilayer films for use in high speed ultrasonic sealing processes. As production speeds are increased, increased amounts of ultrasonic vibrational energy are required to form a quality seal, particularly for cross machine direction seal operation. However, higher amounts of ultrasonic energy can cause fracturing of one or more layers of the film or damage at edges of the resulting package near the seal. As described herein, a multi-layer film having a cavitated layer between a sealing layer and a base film can form a quality cross machine direction ultrasonic seal at speeds above 40 meters per minute relative to the source of the ultrasonic energy without fracturing or damage. The inventors have found that quality ultrasonic cross machine seals can be obtained at speeds of 75 meters per minute and believe that good seals can be achieved at even higher speeds.

As used herein, “cross seal”, “seal in a cross machine direction”, or the like refers to a seal in a direction other than the machine direction of a film being sealed. A cross seal is often a seal in a direction transverse to the machine direction.

As used herein, a “cavitated” layer is a layer having a plurality of voids, pores or cavities. For the purposes of the present disclosure, “void,” “pore,” and “cavity” are used interchangeably, with attributes or characteristics of each of the terms being applied to all the terms. Preferably, the void space in the cavitated layer is sufficiently low to permit a quality ultrasonic seal and is sufficiently high to prevent fracturing or other damage that can occur at higher speeds.

It is believed that the cavitated layer absorbs mechanical energy to prevent fracturing of the base film of a multi-layer film, yet surprisingly transfers sufficient energy to the sealing layer to form a quality seal.

Due to the presence of pores, the cavitated layer is less dense than a layer of the same material that is not cavitated. In various embodiments, a cavitated layer has a density that is at least 10% less than a layer of the same material that is not cavitated, such as at least 15% less than a layer of the same material that is not cavitated or at least 20% less than a layer of the same material that is not cavitated. For example, the cavitated layer may have a density that is between 20% and 40% less dense than a layer of the same material that is not cavitated.

In various embodiments, the density of the cavitated layer is less than the density of a layer of a base film. In some embodiments, the density of the cavitated layer is at least 20% less dense than the layer of a base film, such as at least 25% less dense than the layer of a base film, or at least 30% less dense than the layer of the base film. Generally, the density of the cavitated layer is not more than 80% less dense than the layer of a base film. In some embodiments, the density of the cavitated layer is in a range from about 40% to about 90% of the layer of a base film, such as from about 60% to about 80% of the density of the layer of the base film.

Preferably, the layer of the base film that is denser than the cavitated layer is at least the layer of the base film that is adjacent to the cavitated layer. If the cavitated layer is, for example, adhesive laminated to the bulk film, the adjacent layer of the bulk film would be an adjacent non-tie layer. If the cavitated layer is, for example, extrusion laminated to the bulk film, the adjacent layer of the bulk film would be in contact with the cavitated layer.

The cavitated layer and the denser layer of the base film, such as the adjacent non-tie layer of the base film, can have any suitable density. By way of example, the cavitated layer, in some embodiments, can have a density in a range from about 11 g/m² to about 34 g/m².

In various embodiments, the elastic modulus of the cavitated layer is less than the elastic modulus of a layer of the base film. In some embodiments, the cavitated layer has an elastic modulus that is 90% or less of the elastic modulus of the layer of a base film, such as 80% or less of the elastic modulus of the layer of the base film. Generally, the elastic modulus of the cavitated layer is at least 10% of the elastic modulus of the layer of the base film, such as at least 20% the elastic modulus of the layer of the base film, or at least 30% the elastic modulus of the layer of the base film. In some embodiments, the elastic modulus of the cavitated layer is in a range from about 40% to about 70% of the elastic modulus of the layer of the base film. Preferably, the layer of the base film that has a higher elastic modulus than the cavitated layer is a layer of the base film that is adjacent to the cavitated film, such as an adjacent non-tie layer of the base film.

The cavitated layer and the higher elastic modulus layer of the base film can have any suitable elastic modulus. By way of example, the layer of the base film, in some embodiments, can have an elastic modulus in a range from about 1750 N/mm² to about 3250 N/mm², such as from about 1300 N/mm² to about 3250 N/mm².

In some embodiments, the cavitated layer has a greater void volume than a layer of the base film and has a lower density than the layer of the base film. In some embodiments, the cavitated layer has a greater void volume than a layer of the base film and has a lower elastic modulus than the layer of the base film. In some embodiments, the cavitated layer has a greater void volume than a layer of the base film, has a lower density, and has a lower elastic modulus than the layer of the base film. Preferably, the layer of the base film that has two or more of a lower void volume, a higher density, and a higher elastic modulus than the cavitated layer is a non-tie layer of the base film that is adjacent to the cavitated layer.

The cavitated layer and the base film can be formed from any suitable materials. In some embodiments, the cavitated layer and a layer of the base film are formed from the same material. In some embodiments, the cavitated layer and an adjacent non-tie layer of the base film are formed from the same material.

Pores can be formed in the cavitated layer in any suitable manner. For example, pores can be formed by foaming; mixing of a poragen and a polymer after forming a film layer; incorporation of particles in a polymer, forming a film layer from the polymer, and orienting the polymer to form cavities around the particles. Non-limiting examples of porogens include salts, such as sodium bicarbonate, gelatin beads, sugar crystals, polymeric microparticles, and the like. One or more porogen may be incorporated into a polymer prior to curing or setting. The polymer may then be cured or set, and the porogen may be extracted with an appropriate solvent. The size, amount, interconnectivity, etc. of the pores can be controlled employing various techniques know in the art.

In some embodiments, one or both of the cavitated layer and the one or more layers of the base film comprise, consists essentially of, or consist of thermoplastic polymers, blends of thermoplastic polymers, or blends of thermoplastic polymers with thermosetting polymers. The polymers can comprise a homopolymer, a copolymer such as a star block copolymer, a graft copolymer, an alternating block copolymer or a random copolymer, ionomer, dendrimer, or a combination comprising at least one of the foregoing. The polymers can also be a blend of polymers, copolymers, terpolymers, or the like, or a combination comprising at least one of the foregoing.

Examples of thermoplastic polymers that can be used in the one or more layers of the base film or cavitated layers include polyacetals, polyacrylics, polycarbonates, polyalkyds, polystyrenes, polyolefins, polyesters, polyamides, polyaramides, polylactic acids, polyamideimides, polyarylates, polyurethanes, silicones, polyarylsulfones, polyethersulfones, polyphenylsulfones, polycarbonates, silicones, polycarbonate-polyorganosiloxanes, polyphenylene sulfides, polyhydroxyalkanoates, polyhydroxybutyrate, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxal ines, polypyromellitim ides, polyquinoxalines, polybenzimidazoles, polyoxindoles, polyoxoi soindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polyvinylidene chlorides, polysiloxanes, or the like, or a combination comprising at least one of the foregoing thermoplastic polymers.

In some embodiments, a polymeric material of one or both of a layer of the base film and a cavitated layer includes one or more of a polyolefin, a polylactic acid, a polyester, a polyethylene terephthalate, and a polyvinylidene dichloride. In some embodiments, the polymeric composition of an inner layer comprises a polyolefin, such as one or more of polyethylene, metallocene polyethylene (mPE), polypropylene, and polymethylpentene. In some embodiments, the polymeric composition of the inner layer comprises polypropylene, polyethylene, polylactic acid or polyethylene terephthalate. In some embodiments, a layer of the base film comprises oriented polypropylene and the cavitated layer comprises porous polypropylene. In some embodiments, a non-tie layer of the base film adjacent to the cavitated layer comprises oriented polypropylene and the cavitated layer comprises porous polypropylene.

The sealing layer can be formed from any suitable ultrasonically sealable material. Typically, ultrasonically sealable materials are polymers having a melt temperature of about 85° C. or less. Examples of suitable materials for forming sealing layer include metallocene polyethylene (mPE), polypropylene copolymers, and low density polyethylene.

A base film or a film comprising the base film, a cavitated layer and a sealing layer can include any suitable number of layers. By way of example, the multilayer film can include one or more of a barrier layer, an exterior protective layer, an intermediate layer, a tie layer, a primer layer, and the like. Such additional layer can be a part of the base film or can be positioned exterior to the base film, between the base film and the cavitated layer, or between the cavitated layer and the sealing layer.

In some embodiments, the multilayer film includes no layers between the base film and the cavitated layer. By way of example, the base film and the cavitated layer can be co-extruded. In some embodiments, a multilayer film includes no layers between the cavitated layer and the sealing layer.

Barrier Layer

If included, a barrier layer can function as a gas barrier layer, as a moisture barrier layer, or as a gas barrier and a moisture barrier. Although more than one barrier layer can be used to achieve desired moisture and gas barrier properties. A gas barrier layer can be an oxygen barrier layer, and in some embodiments positioned in the core of the multilayer film such that the barrier layer is not present on an outer surface of the film.

An oxygen barrier is preferably selected to provide an oxygen permeability sufficiently diminished to protect the packaged article from undesirable deterioration or oxidative processes. In some embodiments, a multilayer packaging film will have an oxygen transmission rate (O₂TR) of less than 3, such as less than 2, less than 1, less than 0.1 or less than 0.01, or about 0.06 to 2 g/100 inches² at 24 hours at room temperature (˜23° C.) and 1 atmosphere.

In some embodiments, a moisture barrier, which may be the same or different from a gas barrier, has a water or moisture transmission rate (WVTR) of less than 0.1 g/100 inches² per 24 hours at (23° C.) and 1 atmosphere and 90% relative humidity, such as from about 0.03 to about 0.09 g/100 inches² per 24 hours at room temperature 1 atmosphere, or less than 0.001 g/100 inches² per 24 hours at room temperature and 1 atmosphere and 90% relative humidity.

A barrier layer can comprise any suitable material. An oxygen barrier layer can comprise EVOH, polyvinylidene chloride, polyamide, polyester, polyalkylene carbonate, polyacrylonitrile, nanocomposite, a metallized film such as aluminum vapor deposited on a polyolefin, etc., as known to those of skill in the art. Suitable moisture barrier layers include aluminum foil, PVDC, or polyolefins such as LDPE or LLDPE. The thickness of the barrier layer can be selected to provide the desired combination of the performance properties sought e.g. with respect to oxygen permeability, delamination resistance, and water barrier properties. In some embodiments, a barrier layer has a thickness that is less than 15% of the total film thickness. By way of example, an oxygen barrier layer may have a thickness of less than about 0.45 mil and greater than about 0.05 mil.

An oxygen barrier layer of a film may comprise a metal or metal oxide layer, or EVOH, although oxygen barrier layers comprising polyvinylidene chloride-vinyl chloride copolymer (PVDC or VDC-VC) or vinylidene chloride-methylacrylate copolymer (VDC-MA) as well as blends thereof, can also be used.

Any suitable metal or metal oxide layer can be used as a barrier layer. Examples of suitable metal and metal oxide layers include foils and deposited metals, such as aluminum foil, aluminum oxide, silicon oxide, metalized polyethylene terephthalate, and the like.

Exterior Protective Layer

The multilayer films described herein can, in some embodiments, include an exterior protective layer. An exterior protective layer can be an abuse resistant or protective layer as generally known in the art. Examples of suitable exterior protective layers include: paper, oriented polyester, amorphous polyester, polyamide, polyolefin, cast or oriented nylon, polypropylene, or copolymers, or blends thereof. Oriented films of this or any other layer may be either mono-axially or bi-axially oriented. The exterior layer thickness is typically 0.5 to 2.0 mils. One suitable material for an exterior protective layer is polyester, such as polyester terephthalate, having, for example, a thickness of from about 0.0048 mil to about 0.48 mil.

Intermediate Layer

An intermediate layer is any layer between the exterior layer and the sealing layer and may include oxygen barrier layers, tie layers or layers having functional attributes useful for the film structure or its intended uses. Intermediate layers may be used to improve, impart or otherwise modify a multitude of characteristics: e.g. printability for trap printed structures, machinability, tensile properties, flexibility, stiffness, modulus, tear properties, strength, elongation, optical, moisture barrier, oxygen or other gas barrier, radiation selection or barrier, for example, to ultraviolet wavelengths, etc. Suitable intermediate layers may include: adhesives, adhesive polymers, paper, oriented polyester, amorphous polyester, polyamide, polyolefin, nylon, polypropylene, or copolymers, or blends thereof.

Tie Layer

A multilayer packaging film can include one or more adhesive layers, also known in the art as “tie layers,” which can be selected to promote the adherence of adjacent layers to one another in a multilayer film and prevent undesirable delamination. A multifunctional layer is preferably formulated to aid in the adherence of one layer to another layer without the need of using separate adhesives by virtue of the compatibility of the materials in that layer to the first and second layers. Alternatively, the tie layers can serve as an intermediary to different adhesives that are compatible with different layers or can serve to aid in the adherence of one layer to another layer without the need of using a separate adhesive while serving as an intermediary between a different layer and an adhesive.

In some embodiments, adhesive layers comprise materials found in both the first and second layers that the adhesive layer adheres together. The adhesive layer may suitably be less than 10% and preferably between 1% and 10% of the overall thickness of the multilayer film.

In embodiments where the layers comprise compatible polymers, the layers can be coextruded or laminated by heat rather than adhered via a tie layer.

Film Thickness

A multilayer film as described herein can have any suitable thickness. For example, a multilayer film can have a total thickness of less than about 5 mils, such as thickness of from about 1.0 to 4 mils (25-100 microns).

Packaged Article

A multilayer film as described herein can be used as a packaging film. Preferably, the packaging film is flexible and capable of ultrasonically sealing to itself or another film around an article.

Any suitable article can be contained or sealed within a package containing a multilayer film as described herein.

In some embodiments, a foodstuff is contained or sealed within a package containing a multilayer film as described herein. Any suitable foodstuff can be contained or sealed within a package as described herein. The foodstuffs can be raw or natural foodstuffs or processed foodstuffs. Food processing includes the transformation of raw ingredients into food or transforming forms of food into other forms of food. Food processing often includes using harvested crops or animal products to produce marketable and often long shelf-life products. Processed foodstuffs include products for which additional processing by a consumer may be desired prior to consumption. For example, a foodstuff for which heating, cooking, baking, or the like, may be desired by a consumer prior to consumption may be a processed foodstuff despite not being in its final form (e.g., being unheated, uncooked, unbaked, etc.) prior to delivery to a consumer.

Examples of processed foodstuffs that may be contained or sealed within a package as described herein include a confectionary, a gum, a bakery product, an ice cream, a dairy product, a fruit snack, a chip or crisp, an extruded snack, a tortilla chip or corn chip, a popcorn, a pretzel, a nut, a snack bar, a meal replacement, a ready meal, a soup, a pasta, a canned food, a frozen processed food, a dried processed food, an instant noodle, a chilled processed food, an oil or fat, a sauce dressing or condiment, a dip, a pickled product, a seasoning, a baby food, a spread, a chip or a crisp such as chips or crisps comprising potato, corn, rice, vegetable (including raw, pickled, cooked and dried vegetables), a fruit, a grain, a soup, a seasoning, a baked product such as a ready-to-eat breakfast cereal, hot cereal or dough, an ice cream such as a frozen yogurt, a dairy products such as a yogurt or cheese, ready meal, a soup, a pasta, a canned food, a frozen processed food, a dried processed food, an instant noodle, or a chilled processed food, a beverage including beverages that include fiber or protein a meat or a meat substitute, a pet food, an animal product, and a medical food.

In some embodiments, a foodstuff that may be contained or sealed within a package as described herein includes a vitamin supplement, an infant formula product, a medicinal or pharmaceutical product, or the like.

Ultrasonic Cross Sealing

The multi-layer films described herein can form quality ultrasonic seals in the cross machine direction when run at continuous speeds of 40 meters per second or more, such as at 50 meters per second or more, 60 meters per second or more, or 70 meters per second or more.

Any suitable ultrasonic sealing apparatus can be employed to cross seal the films. Ultrasonic sealing typically employs pinching the film or films to be sealed between an anvil and an ultrasonic horn to form a thermos-mechanical seal. Residence time for film in the ultrasonic sealing apparatus in a cross-machine direction can be short, for example less than 5 milliseconds. Accordingly, it has previously been difficult to form quality cross seals at high continuous machine speeds.

Drawings

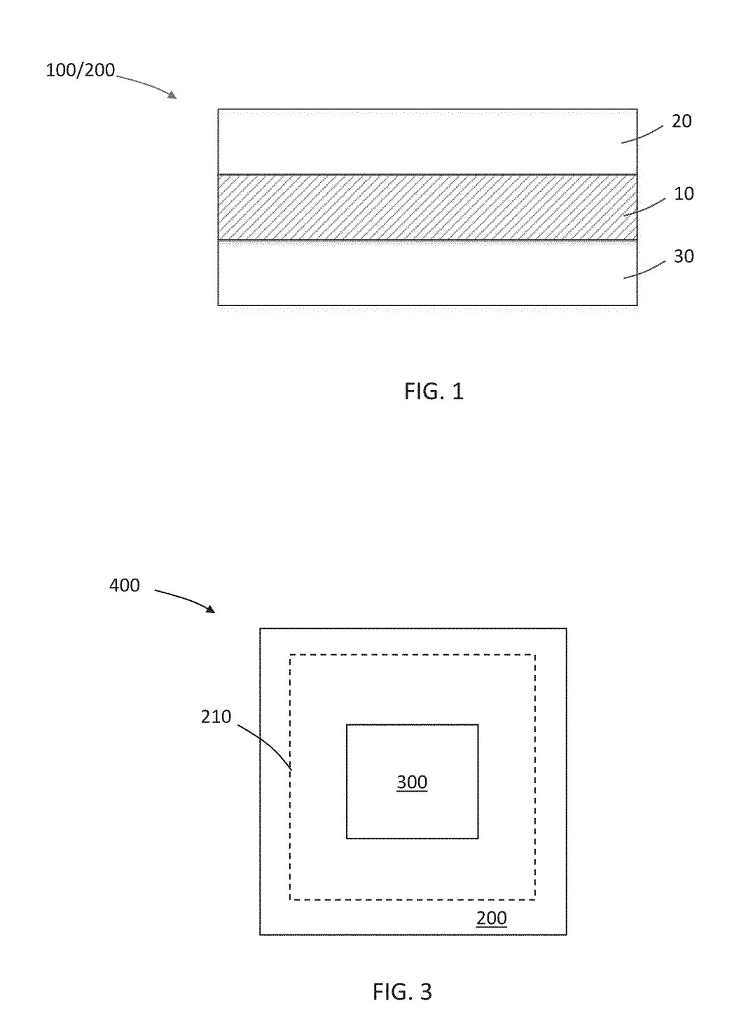

Reference is now made to FIGS. 1-4, which illustrate some embodiments of multilayer films 100, packages 200, and articles 400 and processes described herein.

FIG. 1 illustrates a trilayer film 100, which can serve as a package 200 or packaging film in some embodiments. The depicted film 100 includes a monolayer base film 20, a sealing layer 30, and a cavitated layer 10 between the base film 20 and sealing 30 layers.

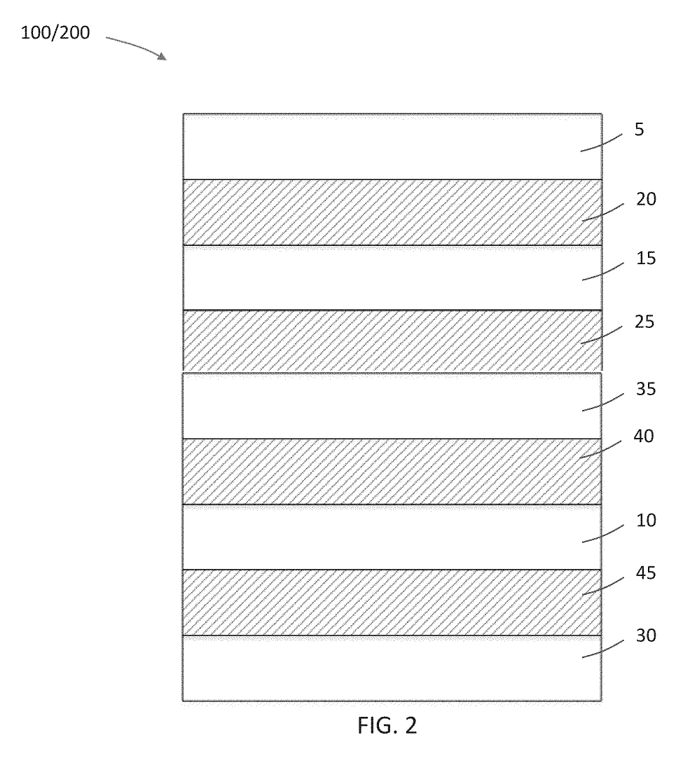

FIG. 2 illustrates a nine-layered film 100, which can serve as a package 200 or packaging film in some embodiments. The depicted film 100 includes an outer protective layer 5, a bulk layer 20, an intermediate layer 15 such as a heat-sealable layer, a barrier layer 25 such as a metal layer, an intermediate layer 35 such as a metal receptive layer, an intermediate layer 40 such as a gloss layer, a cavitated layer 10, a tie layer 45, and a sealing layer 30. One or more adjacent layers selected from the group consisting of the outer protective layer 5, bulk layer 20, intermediate layer 15, barrier layer 25, intermediate layer 35, and intermediate layer 40 can be a part of a base film.

FIG. 3 illustrates a packaged article 400 that includes an article 300 sealed within a package 200. The package 200 includes a multilayer film as described herein (e.g., can be a package as depicted in, for example, FIGS. 1-2). The dashed lines indicate an ultrasonic seal 210 forming a sealed interior of the package 200. The product 300 is sealed within the sealed interior of the package 200. The product 300 can be a foodstuff or any other suitable product.

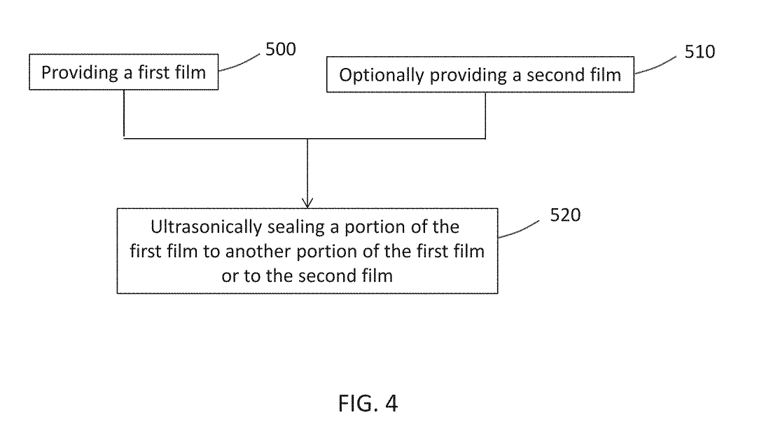

FIG. 4 is a flow diagram of an embodiment of a method for ultrasonically sealing a film as described herein. The method includes providing a first film having a base film, a sealing layer, and a cavitated layer between the base film and the sealing layer (500), and optionally providing a second film having a base film, a sealing layer, and a cavitated layer between the base film and the sealing layer (510). As used herein, “providing” an article such as a film means manufacturing, purchasing, or otherwise obtaining the article such as the film. If used, the second film may be essentially the same as, or may be different from, the first film. The sealing layer of one portion of the first film is preferably brought into contact with the sealing layer of another portion of the first film or with a sealing layer or the second film and ultrasonic energy is directed through the portion of the first film to ultrasonically seal the portion of the first film to itself or to another portion, such as a folded, opposing portion, of the first film or to the second film (520).

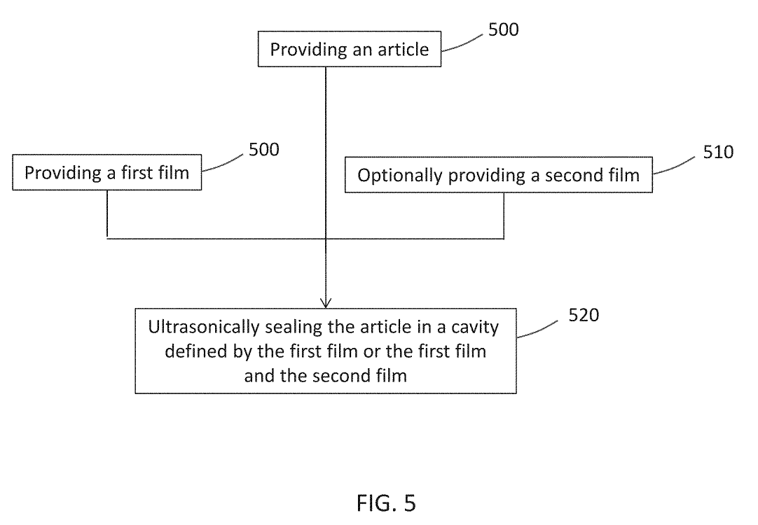

Referring now to FIG. 5, is a flow diagram of an embodiment of a method for ultrasonically sealing a film as described herein. The method includes providing a first film having a base film, a sealing layer, and a cavitated layer between the base film and the sealing layer (500), and optionally providing a second film having a base film, a sealing layer, and a cavitated layer between the base film and the sealing layer (510). The method further includes providing an article (500) and sealing the article in a cavity defined by the first film or defined by the first film and the second film (520). Sealing the article in the cavity can comprises the step of directing the ultrasonic vibrational energy through a portion of the first film to ultrasonically seal the portion of the first film to, for example, a folded opposing portion of the first film or to a second film as depicted in and discussed above with regard to FIG. 4.

The methods depicted in and discussed above with regard to FIG. 4 and FIG. 5 can be accomplished at any speed on a manufacturing line. For example, the first film can be moved at a continuous rate of greater than 40 meters per minute, such as 50 meters per minute or more, or 70 meters per minute or more, while allowing for effective ultrasonic sealing in a cross machine direction.

Definitions

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise. The term “and/or” means one or all of the listed elements or a combination of any two or more of the listed elements.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising” and the like. As used herein, “consisting essentially of” as it relates to an composition, product, method or the like, means that the components of the composition, product, method or the like are limited to the enumerated components and any other components that do not materially affect the basic and novel characteristic(s) of the composition, product, method or the like.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Also herein, the recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” a particular value, that value is included within the range.

As used herein, the term “about” encompasses the range of experimental error that occurs in any measurement.

In the following, non-limiting examples of illustrative embodiments of films, sealing processes and packages are described. These examples are not intended to provide any limitation on the scope of the disclosure presented herein.

### EXAMPLES

Three films were ultrasonically cross sealed to a folded opposing surface of the same film. The ultrasonic sealing conditions are presented in Table 1 below.

TABLE 1
Ultrasonic sealing conditions

| | |
|---|---|
| Machine speed | about 75 meters per minute (constant speed) |
| Frequency | 30 kHz |
| Amplitude | 100% (15.6 micrometers) |
| Dwell time | 3.37 milliseconds |

One film (“comparative film 1”) had the following composition: 79 gauge biaxally oriented polypropylene (BOPP)/adhesive/79 gauge metallized BOPP+Pattern Cold Seal (PCS). Another film (“comparative film 2) had the following composition: 60 g BOPP/Solvent based adhesive (sladh)/1.2 mil cast polypropylene (CPP) copolymer polypropylene (Hi-Z). The third film (“example film”) had the following composition: 79 ga BOPP/sladh/1.38 mil cavitated metallized BOPP.

The relative density of the core film layer (in the case of the three films tested, BOPP) and the density of layer adjacent the sealing layer (BOPP, CPP or cavitated BOPP) is shown in Table 2 below.

As indicated above, the density of a cavitated layer relative to a non-cavitated layer of the same material can be used to gauge the level of cavitation. In the case of the example film, the cavitated BOPP layer was about 67% of the density of the non-cavitated BOPP core layer, indicating substantial cavitation.

The sealed films were tested for failure rate of the seal and modulus in the machine direction and in the transverse direction. Results are presented in Table 2 below.

Briefly, proprietary “Gilmont” testing was performed to quantify impact of cumulative defects of a sealed package—like pinholes, cuts, and/or gaps and channels in sealed areas—by measuring the rate of air egress in inflated packages with a flowmeter. A destructive test, where adhesive septum is attached to the package surface, then a hollow needle connected to air hose from the flowmeter is impaled through both septum and package film. An air stream is introduced into the package headspace at controlled air pressure and flow rate, until it is fully inflated. At this time, air flow will decrease and finally stop when internal package air pressure equals incoming air pressure (example: package with no defects will have air flow reading of 0). Pass/fail criteria is based on acceptable flow rate maximum, which depends on product, and is established by correlating flow rates with package/product shelf life and distribution studies.

The ASTM D882-12; “Tensile Properties, Modulus—film/flex” method was used to test modulus of films. The method utilizes a testing machine having a set of grips for holding test specimens, minimizing slippage and uneven stress distribution, which is capable of constant rate-of-crosshead-movement. Test method covers determination of tensile properties, including tensile modulus of elasticity at a given strain rate. Modulus is an indicator of a material's stiffness generally based on grip separation as a measure of extension of film specimens having uniform width and thickness. Elastic Modulus is calculated by drawing a tangent to the initial linear portion of a specimen load-extension (or stress-strain) curve, selecting any point on this tangent, and dividing the tensile stress by the corresponding strain.

TABLE 2
Percent failure, modulus and relative density

| | Gilmont % | | | |
|---|---|---|---|---|
| | fail, or | MD | TD | Relative |
| Film | failure rate | modulus | modulus | density |
| Comparative film 1 | 72% | 291,816 | 567,823 | 0.91 |
| Comparative film 2 | 25% | 212,259 | 226,751 | 0.93 |
| Example film | 0.5% | 255,121 | 468,472 | 0.67 |

MD = machine direction.
TD = transverse direction.

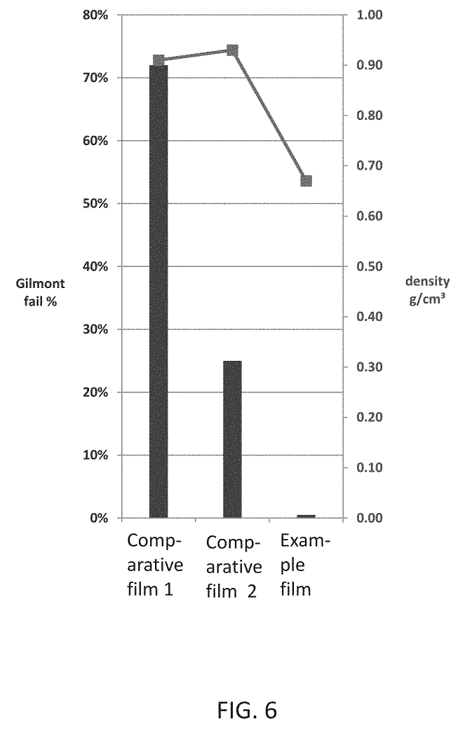

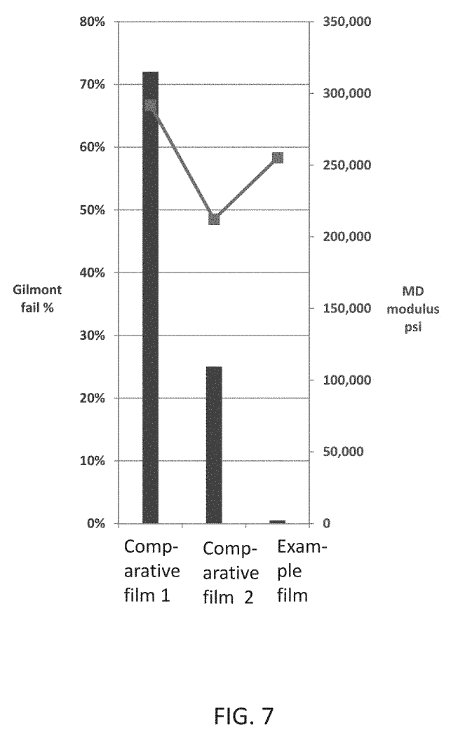

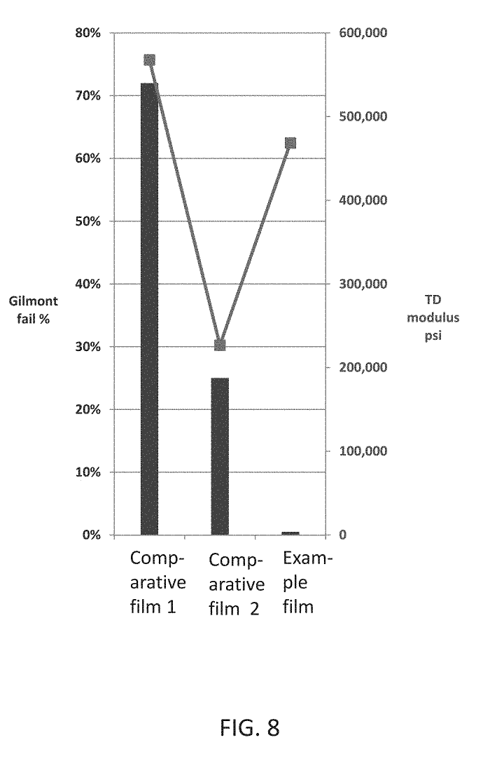

As shown in Table 2, the only tested variable that correlated well with a good seal (low failure rate) is decreased density (and thus cavitation) of the layer adjacent the seal layer. This is also shown in FIGS. 6-8, which provide 2-axis plots of % failure (bar graph) and density (FIG. 6), modulus in the machine direction (FIG. 7), and modulus in the transverse direction (FIG. 8).

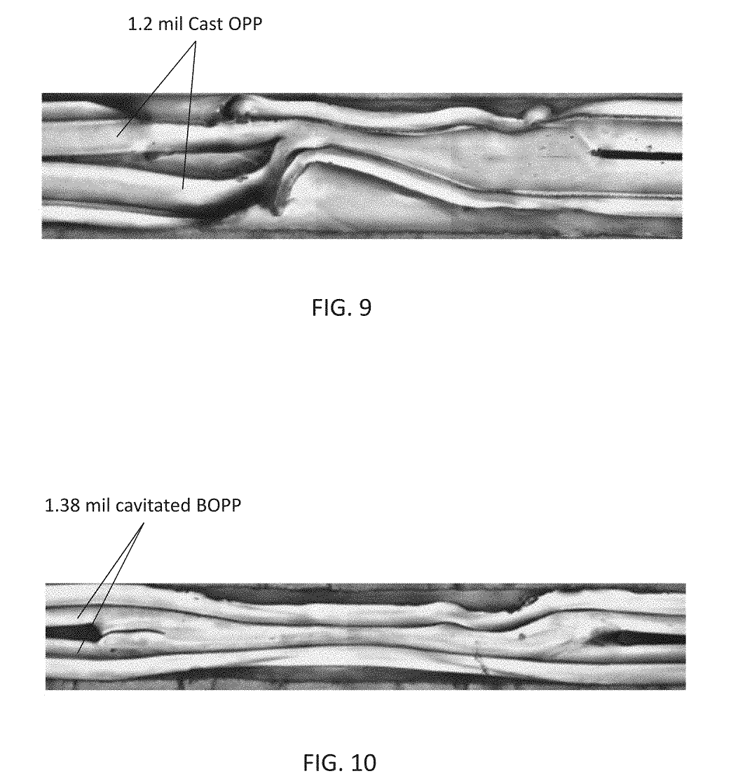

Images of representative cross-sealed regions of comparative film 2 and example film are shown in FIGS. 9 and 10, respectively. As shown, a quality cross seal was formed in the example film (FIG. 10), but not in comparative film 2 (FIG. 9).

ASTM F88/F88M-09; “Seal Strength—film/flex” method may be used to measure the strength of seals for film/flex materials. This test measures the force required to separate a test strip of material containing a sealed portion. Average force per unit width is calculated by the testing machine from the digitized plot of force vs. grip travel. Seal strength is a quantitative measure not only relevant to package integrity, but to measuring the packaging processes' ability to produce consistent seals. This method may be used for process validation, and assessment of process control and capability.

Thus, methods, systems, devices, compounds and compositions for FILMS FOR HIGH SPEED

ULTRASONIC SEALING are described. Various modifications and variations of the layers, films, packages, packaged products and methods disclosed herein will be apparent to those skilled in the art without departing from the scope and spirit of the disclosure. Although aspects of layers, films, packages, packaged products and methods have been described in connection with specific preferred embodiments, it should be understood that the claims that follow should not be unduly limited to such specific embodiments. Indeed, various modifications of the described modes which are apparent to those skilled in chemistry; film and package manufacturing; or related fields are intended to be within the scope of the following claims.

1. A packaged article comprising:
the article; and
packaging in which the article is sealed with at least one ultrasonic cross seal, wherein the packaging includes a multi-layer film, the multilayer film having:
a base film;
a sealing layer; and
a cavitated layer between the base film and the sealing layer.

2. A packaged article according to claim 1, wherein the cavitated layer has a density of at least 10% less than a non-cavitated layer of the same material.

3. A packaged article according to claim 1, wherein the cavitated layer has density of at least 20% less than a non-cavitated layer of the same material.

4. A packaged article according to claim 1, wherein the density of the cavitated layer is less than the density of an adjacent non-tie layer of the base film.

5. A packaged article according to claim 4, wherein the density of the cavitated layer is at least 10% less than the density of the adjacent non-tie layer.

6. A packaged article product according to claim 4, wherein the density of the cavitated layer is at least 30% less than the density of the adjacent non-tie layer.

7. A packaged article according to claim 1, wherein the cavitated layer comprises a polyolefin.

8. A packaged article according to claim 7, wherein the polyolefin comprises polypropylene.

9. A packaged article according to claim 1, wherein the base film comprises a polyolefin.

10. A packaged article according to claim 9, wherein the polyolefin comprises polypropylene.

11. A packaged article according to claim 1, wherein the article sealed in the packaging comprises a food product.

12. A method, comprising:
providing a first film having a base film, a sealing layer, and a cavitated layer between the base film and the sealing layer; and
directing ultrasonic vibrational energy through a portion of the first film to ultrasonically cross seal the portion of the first film to a folded opposing portion of the first film or to a second film.

13. A method according to claim 12, further comprising providing an article and sealing the article in a cavity defined by the first film or defined by the first film and the second film; wherein sealing the article in the cavity comprises the step of directing the ultrasonic vibrational energy through a portion of the first film to ultrasonically seal the portion of the first film to another portion of the first film or to a second film.

14. A method according to claim 12, further comprising moving the film at a continuous speed of 50 meters per minute or more relative to a source of the ultrasonic energy as the ultrasonic energy is directed through the portion of the film.

15. A method according to claim 14, wherein moving the film comprises moving the film at a continuous speed of 70 meters per minute or more.

16. A method according to claim 13, wherein the article is a food product.
